(19) United States
(12) Patent Application Publication
(10) Pub. No.: US 2024/0293876 A1
(43) Pub. Date: Sep. 5, 2024

(54) DEBURRING TOOL WITH DEBURRING BLADE FOR DEBURRING THE EDGES OF HOLES

(71) Applicant: Heule Werkzeug AG, Balgach (CH)

(72) Inventors: Harry Studer, Balgach (CH); Roman Faessler, Marbach (CH)

(21) Appl. No.: 18/574,622

(22) PCT Filed: Jun. 30, 2021
(86) PCT No.: PCT/EP2021/067979

§ 371 Date: Dec. 27, 2023

(51) Int. Cl. B23B 51/10

(52) U.S. Cl. CPC B23B 51/101; B23B 51/102

(57) ABSTRACT

The invention relates to a deburring blade for deburring the edges of holes on workpieces, containing at least one cutting blade, which comprises at least one cutting portion having at least one cutting edge with an associated free surface which is designed as a cutting part, an associated control surface adjoining the cutting edge and being designed as a non-cutting part, the cutting blade being held in a tool holder which is rotatable about an axis of rotation in at least one direction of rotation, and the cutting edge transitioning into a helically twisted surface which forms a continuous transition from the cutting part to the non-cutting part.

The invention relates to a deburring tool and a deburring blade for deburring the edges of holes according to the preambles of claims 1 and 8.

Deburring tools are used to remove burrs from mostly metallic workpieces. Burrs are sharp edges or splinters which form during a machining or manufacturing process. The deburring tools have at least one deburring blade, which is usually designed as a replaceable hard metal blade with a material-dependent coating.

For example, with the so-called COFA blade, which originates from the same applicant, a deburring blade has become known, that deburrs uneven edges of holes evenly and radially with a forward and backward deburring action. Typical applications for the COFA deburring tool are fork pieces, common rails, castings, pipes with transverse holes and generally workpieces with transverse holes in main holes.

Other blades from the same applicant are known as DEFA, GHS, SNAP, GHS and DRALL blades.

EP 1 839 788 A1 discloses a deburring blade for a deburring tool for deburring the edges of through holes of a workpiece, wherein the cutting surface on the deburring blade assumes a negative angle in the direction of the workpiece surface. The cutting geometry consists of only a first cutting edge and a non-cutting control surface. The transition from the cutting to the non-cutting part is not continuous.

EP 2 208 566 B1 discloses a cutting blade for chip-removing cutting tools that are difficult to manipulate by hand. The cutting blade consists of only one cutting edge with a control surface which forms a transition edge towards the cutting edge. The transition from the cutting to the non-cutting part is therefore not continuous.

EP 0 370 210 A1 also discloses a deburring tool with a cutting blade for bilateral deburring of the edges of through holes, wherein a sliding portion deviating from the angle of the cutting edge is provided on the axially outer part of the cutting blade, which sliding portion then transitions into a sliding radius formed on the end face of the cutting blade. However, the cutting blade only has a first cutting edge, so that only a limited chamfering or deburring quality is achieved with this cutting blade.

EP 1 579 937 B1 discloses a deburring blade for deburring the edges of holes, wherein the cutting blade has a cutting portion with a first cutting edge, which is directly or indirectly adjoined by a second cutting edge, which in turn is indirectly adjoined by a non-cutting free edge via a transition, which free edge is set back radially to the axis of rotation in relation to the second cutting edge.

In EP 1 579 937 B1, the transition between the cutting and non-cutting part is achieved with two surfaces which necessarily form a transition surface in the form of a gusset. This has the following two disadvantages shows:
a) The requirements on the manufacturing accuracy of the cutting blade are very high, in particular the cutting edge and the free edge or control edge must interlock in order to achieve the desired effect.
b) The gusset causes an undesirable secondary burr in the chamfering or deburring process, depending on the material being machined.

The object of the present invention is therefore to provide a deburring blade with a cutting blade the cutting geometry of which can be manufactured more easily and economically and at the same time to improve the chamfering or deburring quality.

In order to achieve the object set, the invention is characterized by the technical teaching of claim 1 and claim 8.

An essential feature of the invention is that a helically twisted surface which has a continuous transition from the cutting part to the non-cutting part is associated with a cutting edge.

The term twisting or twisted surface is understood to mean a rotated or wound surface. The twisted surface is helical or has the shape of a helical line. Such a surface is created, for example, when a torsional moment acts on a flat surface or a bar. As a result, the twisted surface is turned or warped, i.e. the cross-sectional surfaces do not remain flat. The helically twisted surface can also be regarded as a winding body, which has no edges or steps, but only windings and curvatures.

The twisted surface creates a continuous transition from the cutting to the non-cutting part, which has a positive effect on the chamfering process and deburring quality. A further advantage of the twisted surface is that this surface is much easier to manufacture, making the deburring blade much more economical to produce.

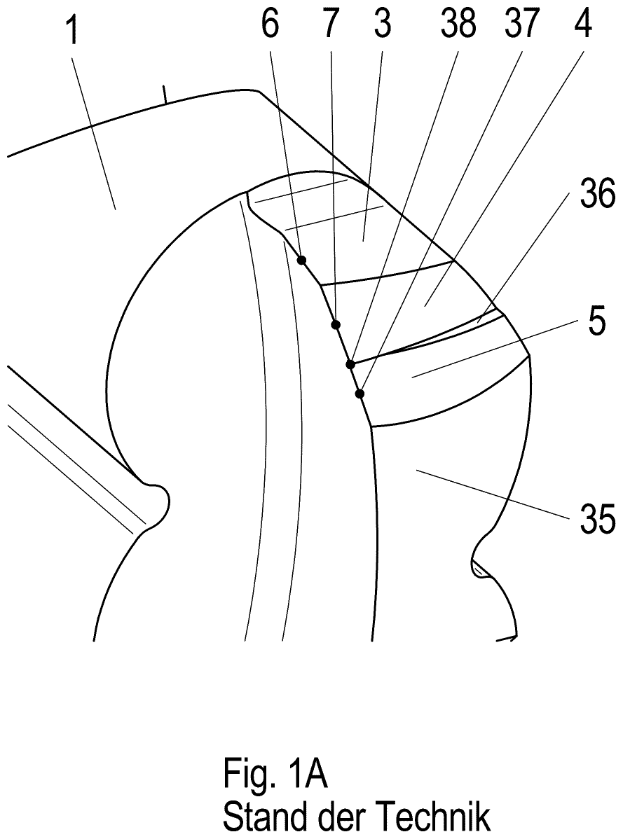

In EP 1 579 937 B1, the transition between the second cutting edge and the non-cutting free edge, i.e. the transition from the cutting to the non-cutting part, is formed by two surfaces (free surface and control surface), wherein a gusset transition surface (see reference 36 in FIG. 1A) is created at the same time. The transitions of the individual surfaces are edge-shaped and thus non-continuous. In contrast to this, in the embodiment according to the invention these transitions are achieved by only one rotated, twisted surface, wherein at the same time the gusset transition surface is eliminated or completely omitted.

The deburring blade according to the invention thus has a special cutting edge geometry which is particularly suitable for deburring tools for forward and backward deburring (left- and/or right-turning blades), as well as for chamfering tools and countersinking tools.

In a preferred embodiment, the deburring blade for deburring the edges of holes on workpieces has at least one cutting blade with at least one cutting portion with at least one cutting edge and at least one control surface, wherein the cutting blade is held in a tool holder which is rotatable about an axis of rotation in at least one direction of rotation. The cutting blade is designed as follows, wherein the following description is based on the longitudinal center axis of the base body of the cutting blade:
Viewed in the axial direction, a first cutting edge is first provided as the edge boundary of a first free surface, wherein the first cutting edge is either aligned exactly vertically or has an angle to the vertical. The vertical first cutting edge removes a large burr to be removed from the edge of the hole.
A second cutting edge directed obliquely inwards towards the longitudinal center axis, and outwards from the center of the base body of the cutting blade adjoins the free front end of this first vertical cutting edge as the edge boundary of a second free surface, which second cutting edge forms any angle between 0° and 90° relative to the first vertical cutting edge. The chamfers are precisely machined with the adjoining inclined second cutting edge, i.e. the surface and the angle of the countersink are very precisely maintained.
The twisted surface according to the invention adjoins the front free end of this inclined second cutting edge, as the edge boundary of a control surface.

The cutting blade according to the invention has cutting edges preferably directed forwards (in relation to the relative movement to the workpiece) and also cutting edges arranged in a rearward direction. The cutting blade is thus suitable both for forward deburring and for backward deburring. However, the invention is not limited to this.

The invention can also provide that only the cutting blade has the cutting edges according to the invention on one side, while, for example, the cutting edges present for backward deburring can also be omitted.

The subject matter of the present invention results not only from the subject matter of the individual claims, but also from the combination of the individual claims with one another.

All the information and features disclosed in the documents, including the abstract, in particular the spatial configuration shown in the drawings, are claimed as being essential to the invention insofar as they are new, either individually or in combination, compared with the prior art.

In the following, the invention is explained in more detail with the aid of drawings which merely illustrate one embodiment. Further features and advantages of the invention which are essential to the invention are apparent from the drawings and their description.

In particular:

FIG. 1A shows a cutting blade according to the prior art

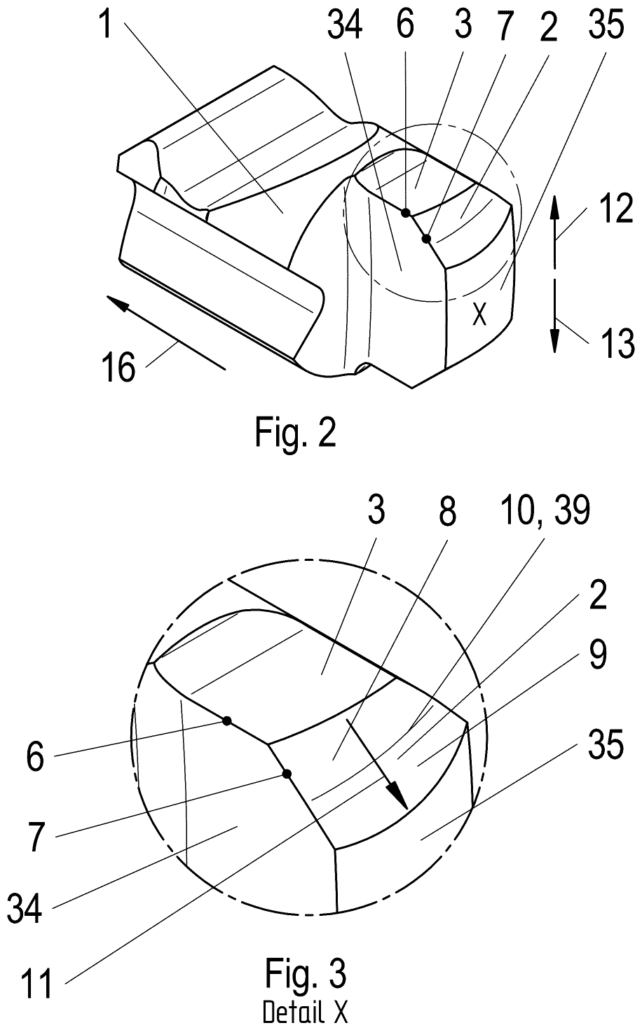

FIG. 2 shows a perspective front view of a cutting blade cutting forwards and backwards

FIG. 3 shows an enlarged view of the cutting portion shown in FIG. 1 under reference X

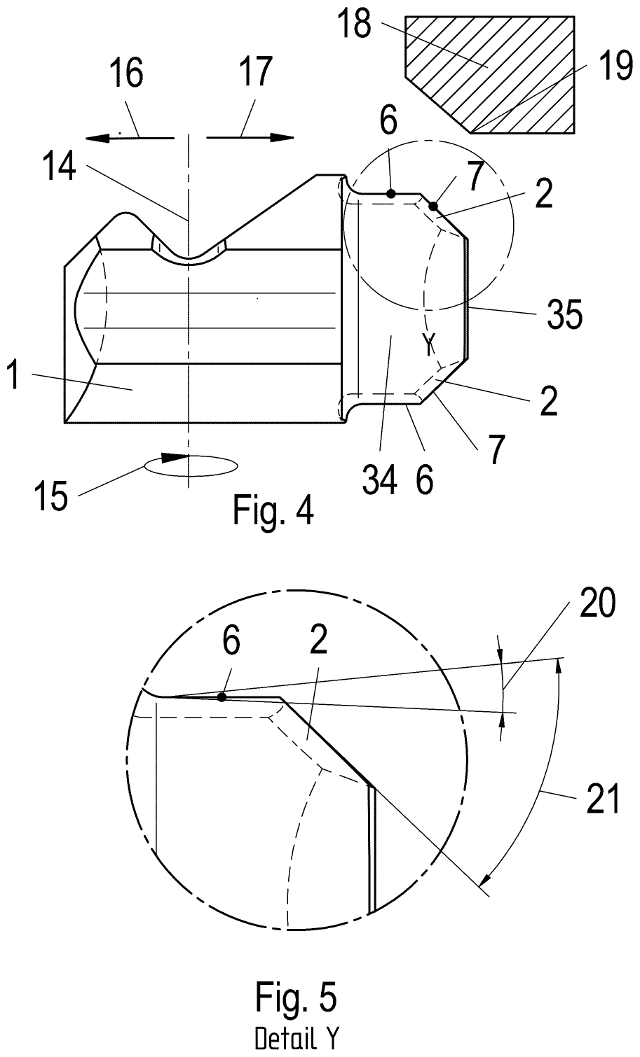

FIG. 4 shows a view of the cutting blade from above

FIG. 5 shows an enlarged view of the cutting portion shown in FIG. 3 under reference Y with different angle data

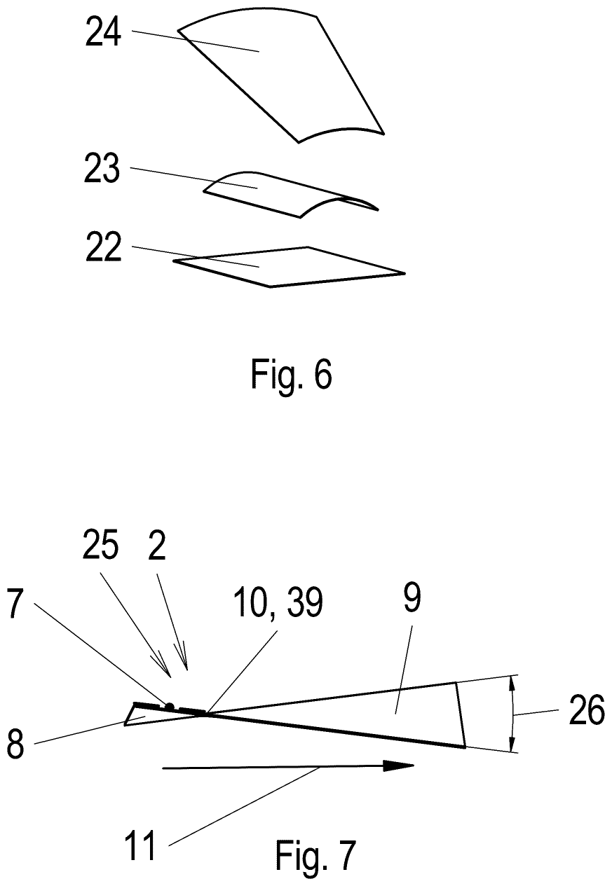

FIG. 6 shows possible basic shapes of the rotated surface

FIG. 7 shows a schematic representation of the rotation (torsion) using the example of a plane as basic shape

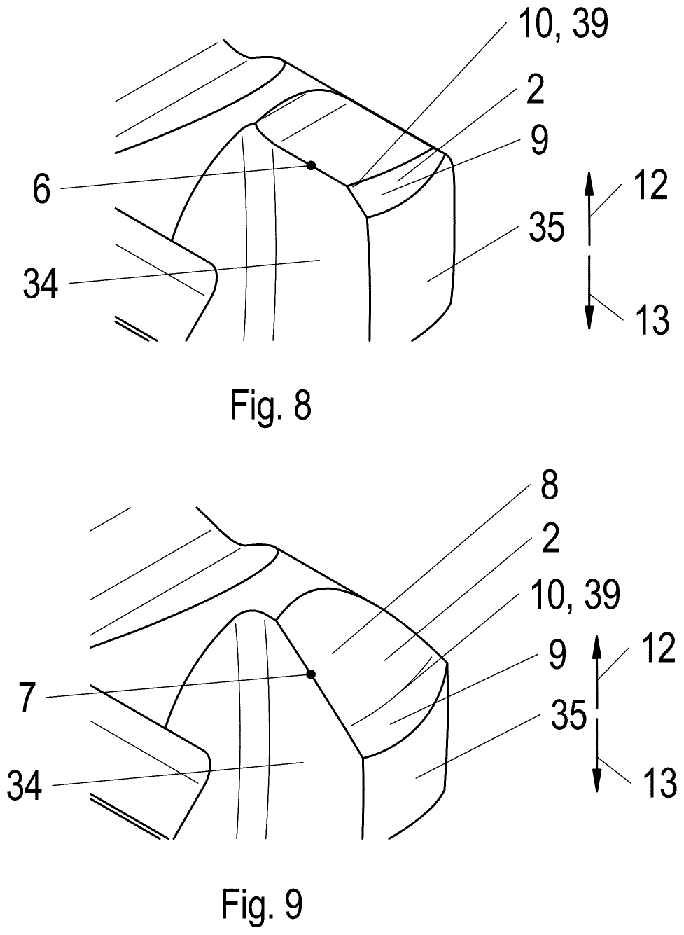

FIG. 8 shows a variant of the cutting blade with only a first cutting edge and the rotated control surface from neutral to non-cutting

FIG. 9 shows a variant of the cutting blade with only one rotated surface, which acts continuously from cutting to neutral up to non-cutting

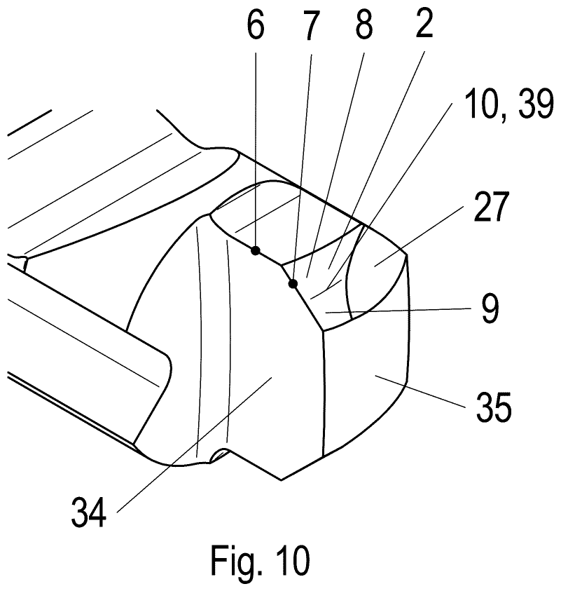

FIG. 10 shows a variant of the cutting blade with an additional free surface

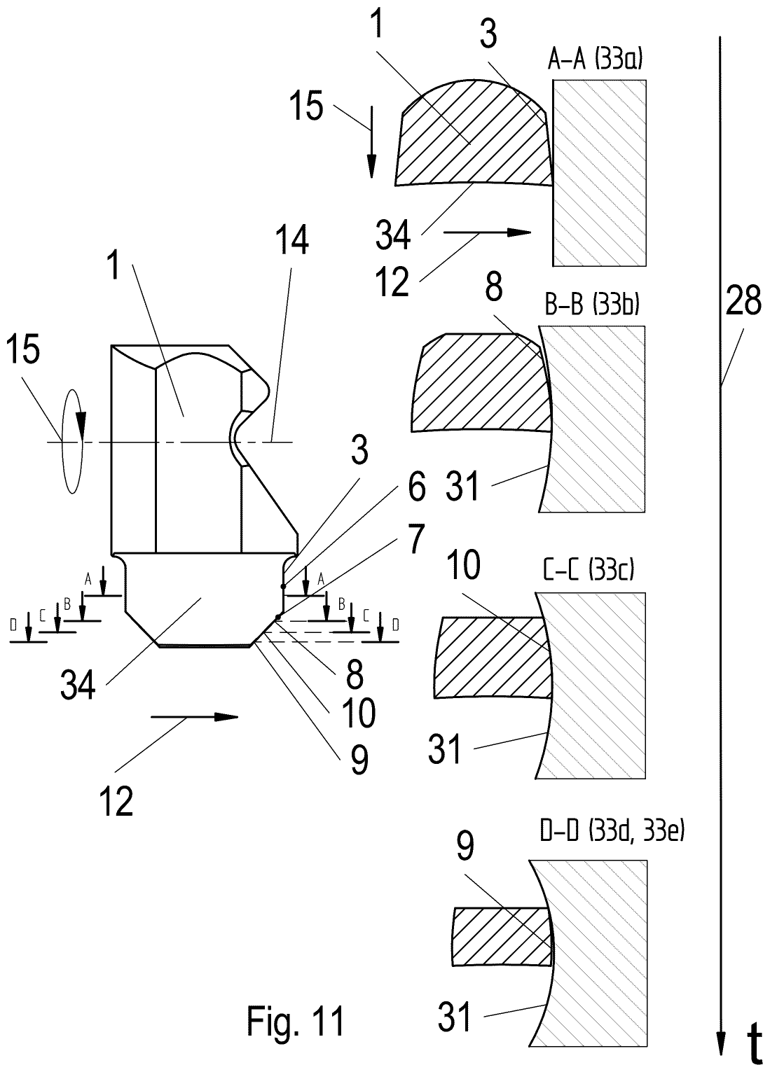

FIG. 11 shows sectional views through the cutting geometry

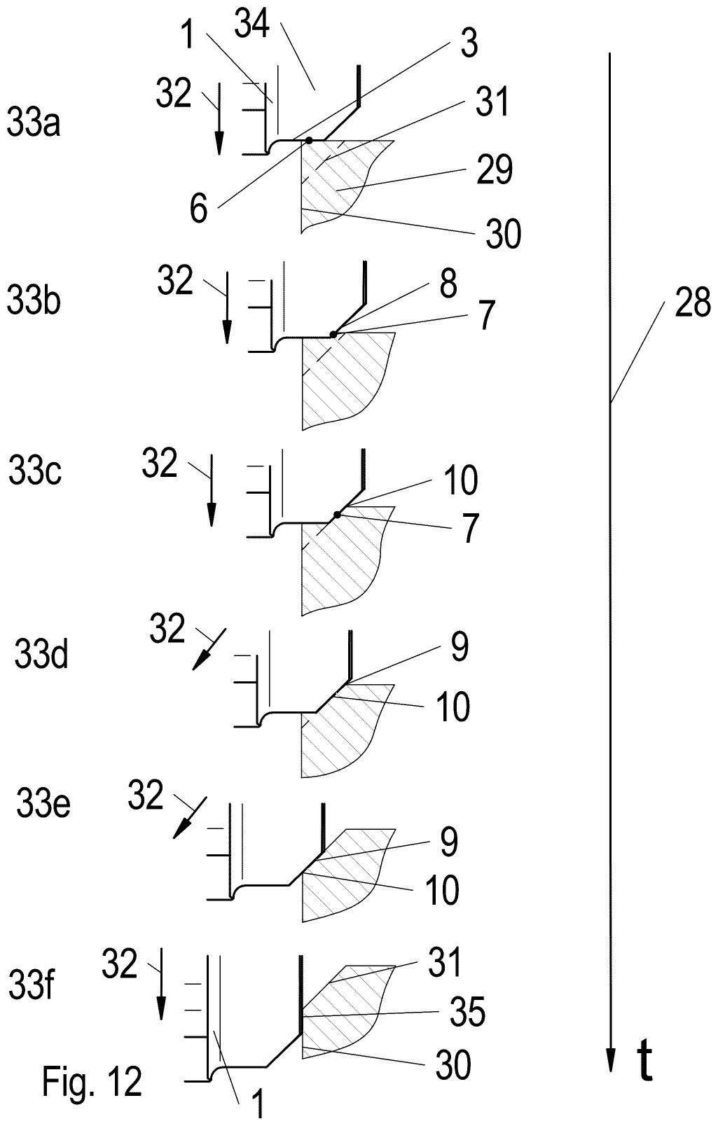

FIG. 12 shows a view from above of the cutting blade and a representation of the steps of chamfering or deburring process

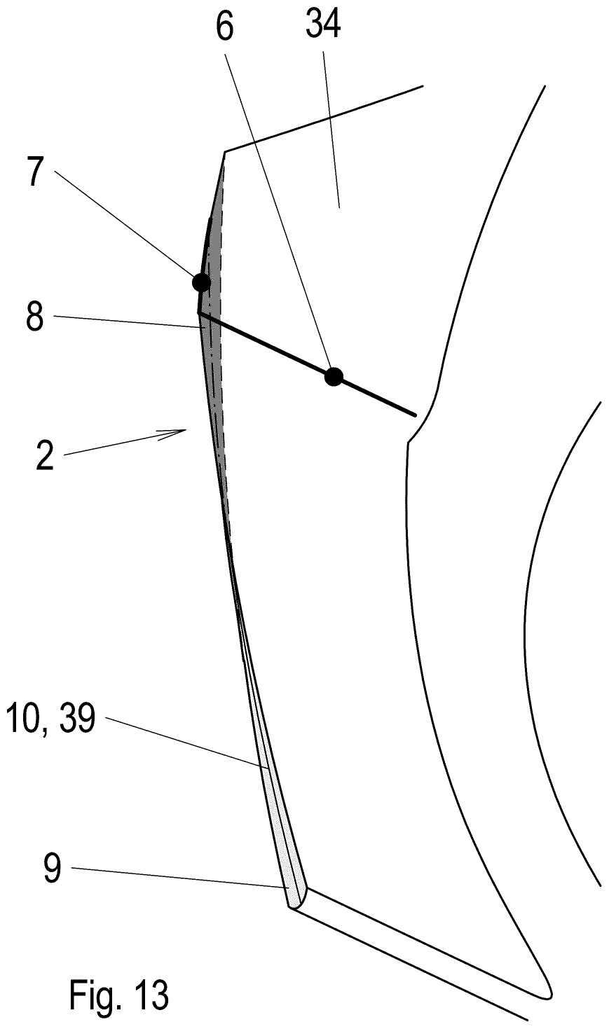

FIG. 13 shows a schematic representation of the twisted surface

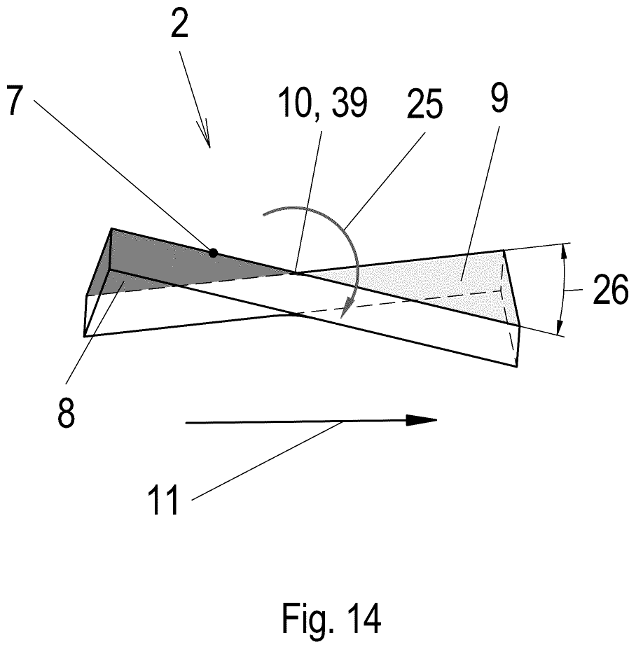

FIG. 14 shows a schematic representation of the twisted surface with representation of the torsion axis

FIG. 1A shows a detail of a cutting portion of a cutting blade 1 according to the prior art. The cutting portion has a first cutting edge 6, behind which a free surface 3 is recessed.

The free surface 3 serves to clear the cutting edge 6.

The first cutting edge 6 is adjoined at an angle by a second cutting edge 7, which is also referred to below as the S-cutting edge. The free surface 3 associated with the first cutting edge 6 transitions into a free surface 4 associated with the second cutting edge 7. The two free surfaces 3 and 4 are recessed behind the two cutting edges 6, 7 to enable them to perform a cutting action. The obliquely inclined cutting edge 7 is straight in itself and runs straight up to the transition 38.

The cutting edges 6, 7 can be straight or curved. The second cutting edge 7 is adjoined by a lower free edge 37 with a control surface 5, neither of which performs a cutting action. However, the control surface 5 is used to precisely control the cutting blade 1.

The control surface 5 is bounded on the one hand on the side of the cutting edges 6, 7 by the free edge 37 and on the other hand on the side opposite the cutting edges 6, 7 circumferentially opposite the direction of rotation 15 by the edge boundaries of a gusset 36, which is formed between the free surface 4 and the control surface 5.

The gusset 36 is formed as a shoulder between the two adjacent surfaces 4 and 5, which are offset relative to each other in the plane of the drawing in FIG. 1A. A sliding surface 35 adjoins the control surface 5. The two surfaces 5 and 35 are separated from each other by an arcuate edge.

During the deburring process, the cutting edge 7 comes into contact with the chamfer to be deburred. The cutting action of the cutting edge 7 is only terminated when the desired chamfer size 19 has been reached.

FIG. 2 shows the cutting blade 1 according to the invention with a cutting portion. The cutting blade 1 has a body that can be rotated about an axis of rotation 14, for example in the direction of rotation 15.

Only one cutting portion is shown in FIG. 2. However, it is also possible that the cutting blade 1 has two cutting portions for forward and backward deburring, wherein the two cutting portions are arranged mirror-symmetrically to each other with respect to a center line. However, this is not a necessary solution. For example, the cutting portion for forward deburring can be designed differently than the cutting portion for reverse deburring.

The cutting blade 1 has a cutting portion with a first cutting edge 6, which acts mainly in a axial direction (arrow direction axially backwards 12 and/or arrow direction axially forwards 13) and performs the main cut. Behind the first cutting edge 6 there is a recessed free surface 3, which serves to clear the cutting edge 6. The cutting edge 6 is also known as the D-cutting edge and forms a vertical cutting surface with which a particularly aggressive cutting action is achieved with good efficiency.

A second cutting edge 7 adjoins the first cutting edge 6 at an angle 20. The angle 20 can be changed. The angled cutting edge 7 cuts with high precision-because it enters the hole of the workpiece 18 at an angle.

The free surface 3 associated with the first cutting edge 6 transitions into a rotated (twisted) surface 2 associated with the second cutting edge 7. The twisted surface 2 is helical and replaces the free surface 4, the control surface 5 and the gusset 36 as shown in FIG. 1A (prior art).

The cutting blade 1 thus consists of the first cutting edge 6, which is adjoined by a helical, twisted surface 2, wherein the twisted surface has a second cutting edge 7, a cutting part 8 and a non-cutting part 9 due to its rotation (torsion) 25. The non-cutting part 9 corresponds to the control surface 5 from the prior art, which causes the cutting blade 1 to retract in the direction of the arrow 16.

Starting from the second cutting edge 7, the torsion axis 39 extends in an approximately orthogonal direction, around which the twisted surface 2 is rotated helically. Preferably, the angle between the longitudinal extension of the second cutting edge 7 and the torsion axis 30 is approximately 75-105°.

The torsion axis 39 is arranged approximately in the center of the second cutting edge 7. However, an off-center position of the torsion axis 39 is also possible.

FIG. 3 shows the detail X from FIG. 2. The control surface is now part of the twisted surface 2 and causes the blade to retract in the direction of arrow 16. At the same time, the chamfer or deburring size 19 in the workpiece 18 is limited. The transition from the second cutting edge 7 to the actual control surface is only formed by a common twisted surface 2, which has a cutting part 8 and a non-cutting part 9. The twisted surface 2 thus has a continuous transition from the cutting part 8 to the non-cutting part 9 in the direction of arrow 11.

Within the continuous transition, the twisted surface 2 forms a neutral point 10 in the direction of arrow 11 relative to the deburring or chamfering process. The point 10 precisely determines the transition from the cutting part 8 to the non-cutting part 9, wherein its position corresponds to the deburring or chamfering size 19 on the workpiece 18. The neutral point 10 corresponds to the torsion axis 39.

FIG. 4 shows the workpiece 18 with the chamfer size or deburring size 19 in relation to the cutting blade 1. The cutting blade 1 rotates in the direction of rotation 15 around the axis of rotation 14 and is extended in the direction of arrow 17 and retracted in the direction of arrow 16.

A sliding surface 35 adjoins the twisted surface 2. The sliding surface 35 does not perform any cutting action or any control function. It is merely a front end of the cutting blade. The sliding surface 35 is cambered so as not to cause any damage when moving onto a hole in the workpiece 18.

According to FIG. 5, the first cutting edge 6, which acts mainly axially, is at an angle 20 of −30° to +30° relative to the horizontal plane. The rotated (twisted) surface 2 is at an angle 21 greater than 0° to the horizontal plane, wherein the angle 21 is greater than angle 20 but less than 90°.

FIG. 6 shows the rotated (twisted) surface 2, the basic shape of which consists of a plane 22 (rectangle, square, angular surface) or a cylindrical shape 23 or a conical shape 24. The basic shape 22, 23 or 24 is superimposed by a rotation (torsion) 25, whereby the twisted surface 2 is formed. The twisted surface 2 is therefore a combination of the basic shape 22, 23, 24 and a rotation (torsion) 25.

According to FIG. 7, the rotation (torsion) 25 divides the twisted surface 2 into a cutting part 8 and a non-cutting part 9 along the direction of arrow 11 from cutting to non-cutting. The transition between parts 8 and 9 is located in the region of the neutral point 10.

The second cutting edge 7, which is formed by the cutting part 8 of the rotated (twisted) surface 2, extends up to the neutral point 10. The angle of rotation (torsion angle) 26 is between 0° and 30°.

The cutting portion of the cutting blade 1 essentially consists of the first cutting edge 6 and a twisted surface 2, which forms a second cutting edge 7 and the cutting and non-cutting parts 8, 9 due to its rotation (torsion) 25.

FIG. 8 shows a further embodiment of the cutting blade 1 according to the invention. The active cutting part of the blade consists of a first cutting edge 6, which acts mainly axially, and a subsequent twisted surface 2, which acts continuously from the neutral point 10 to the non-cutting part 9. The second cutting edge 7 is omitted.

The chip groove 34 is located on the side of the cutting blade and is preferably arcuate.

FIG. 9 shows a further embodiment of the cutting blade 1 according to the invention. The acting cutting edge part of the cutting blade 1 consists of only one twisted surface 2, which acts continuously from the cutting part 8 via the neutral point 10 to the non-cutting part 9. The first cutting edge 6 is omitted.

According to FIG. 10, the non-cutting part 9 of the twisted surface 2 is optionally limited or cleared by an additional surface 27 at the front (face-side) lower blade corner. This improves the angular accuracy of the chamfer.

FIG. 11 uses sectional views A-A to D-D to show how the free surface 3 and rotated (twisted) surface 2 work during the cutting process.

In particular, the sectional views B-B to D-D show the mode of operation of the twisted surface 2 with its cutting part 8, the neutral point 10 and the non-cutting part 9, which ensure a continuous transition from cutting to non-cutting.

Reference numerals 33a to 33e in the sectional views A-A to D-D refer to the chronological sequence or the process steps of the chamfering or deburring process as shown in FIG. 11.

Section A-A shows the cutting property of the first cutting edge 6, which is formed by the surface 3 and the chip groove 34 in axial direction 12.

Section B-B shows the second cutting edge 7, which is formed by the cutting part 8 of the twisted surface 2 and the chip groove 34. The second cutting edge 7 only extends from the first cutting edge 6 to the neutral point 10 of the twisted surface 2.

Section C-C shows the neutral point 10 of the twisted surface 2. At this point, the chamfer or deburring size 19 is reached and the blade continuously transitions from the cutting state to the non-cutting state.

Section D-D shows the non-cutting part 9 of the twisted surface 2, which causes the blade to retract. The desired chamfer 31 in the workpiece 18 is produced.

FIG. 12 shows a view from above of the cutting blade 1 during the chamfering or deburring process in process steps 33a to 33f.

FIG. 33a shows the chamfering or deburring process, wherein the first cutting edge 6 which is purely acting axially, is in engagement with the workpiece 29.

In FIG. 33b, the second cutting edge 7 engages with the workpiece 29 immediately afterwards, wherein the cutting blade 1 moves in the axial direction in the direction of arrow 32. This causes the chamfer or deburring size 19 to increase. According to FIG. 33b, both cutting edges 6 and 7 cut together.

In FIG. 33c, the cutting blade 1 has cut so far into the workpiece 29 that the neutral point of the twisted surfaces 2 is now engaged. At this point, the chamfer or deburring size 19 is reached and the cutting blade 1 subsequently changes its direction of movement 32, which now runs parallel to the contour of chamfering or deburring 31.

FIG. 33d shows the next process step. The non-cutting part 9 of the twisted surface 2 is now in engagement with the workpiece 29. The first cutting edge 6 and the second cutting edge 7 now finish cutting the chamfer or deburring 31. The cutting blade 1 now moves along the non-cutting part 9 of the twisted surface 2 in the direction of arrow 32 parallel to the contour of the chamfer or deburring 31.

In FIG. 33e, the cutting blade 1 has finished cutting the entire chamfer or deburring 31. Only the non-cutting part (9) of the twisted surface (2) is still engaged and continues to move the blade in the direction of the arrow (32) parallel to the chamfer or deburring contour.

FIG. 33f shows the last process step, wherein the cutting blade 1 moves with the sliding surface 5 along the hole wall 30 through the workpiece 29.

FIG. 13 shows a schematic representation of the twisted surface 2. The twisted surface 2 is twisted helically around the torsion axis 39. The second cutting edge 7 is located at the front end and is adjoined by the cutting part 8 and the non-cutting part 9. The neutral point 10 is the torsion axis 39, around which the cutting part 8 and non-cutting part 9 are rotated.

The cutting part 8 corresponds to the free surface 4 and the non-cutting part 9 to the control surface 5 from the prior art. It is crucial that the transition between the cutting part 8 and the non-cutting part 9 is continuous. This means that, unlike in the prior art, there are no edges or steps.

FIG. 14 shows a further representation of the twisted surface 2. The surface 2 is rotated around the torsion axis 39 with a rotation 25 by the twist angle 26. The cutting part 8 and the non-cutting part 9 adjoin without an edge and with a continuous transition the second cutting edge 7 on the edge side.

### LIST OF REFERENCE NUMERALS

1. cutting blade
2. rotated (twisted) surface
3. free surface of first cutting edge
4. free surface (S)
5. control surface
6. first cutting edge
7. second cutting edge
8. cutting part of the rotated (twisted) surface (2)
9. non-cutting part of the rotated (twisted) surface (2)
10. neutral point of the rotated (twisted) surface (2)
11. direction of arrow
12. direction of arrow axially backwards
13. direction of arrow axial forwards
14. axis of rotation
15. direction of rotation
16. arrow direction-retraction
17. arrow direction-extension
18. workpiece
19. chamfer size or deburring size
20. angle (first cutting edge)
21. angle (rotated surface)
22. plane
23. cylinder shape
24. cone
25. rotation (torsion)
26. angle of rotation (torsion angle)
27. additional free surface
28. direction of arrow-time axis
29. workpiece
30. hole wall
31. chamfer, deburring
32. direction of arrow for blade movement
33a to 33f. steps of chamfering or deburring process
34. chip groove
35. sliding surface
36. gusset
37. free edge
38. transition
39. torsion axis

1. A deburring blade for deburring the edges of holes on workpieces, wherein at least one cutting blade can be held in a tool holder, which can rotate around an axis of rotation in at least one direction of rotation, wherein the cutting blade comprises at least one cutting portion having at least one first cutting edge and at least one second cutting edge, wherein a free surface is associated with the second cutting edge, which free surface is designed as a cutting part, and a control surface is associated with the second cutting edge, which control surface is designed as a non-cutting part, wherein the second cutting edge transitions into a helically twisted surface which is forms a continuous transition from the cutting part to the non-cutting part, wherein the second cutting edge directly adjoins at an angle the first cutting edge and in that the first cutting edge has an associated free surface, which transitions into the twisted surface which is associated with the second cutting edge.

2. The deburring blade according to claim 1, wherein the cutting blade comprises two cutting portions for forward and backward deburring, wherein both cutting portions are arranged mirror-symmetrically to each other with respect to a center line.

3. The deburring blade according to claim 1, wherein, starting from the second cutting edge, a torsion axis extends in an approximately orthogonal direction, about which axis the twisted surface is rotated helically with a rotation.

4. The deburring blade according to claim 1, wherein the twisted surface forms a second cutting edge due to its rotation, as well as a non-cutting part, which is designed as a control surface.

5. The deburring blade according to claim 1, wherein the continuous transition of the twisted surface has a neutral point which determines the transition from the cutting part to the non-cutting part, wherein the neutral point corresponds to the position of the deburring or chamfering size on the workpiece.

6. The deburring blade according to claim 1, the twisted surface has an angular shape, a cylindrical shape or a conical shape as the basic shape, which is superimposed by a rotation.

7. The deburring blade according to any one of claims 1 to 6, characterized in that the non-cutting portion of the twisted surface is delimited or cleared on the front (front side) lower corner of the cutting blade by an additional surface, whereby the angular precision of the chamfer is improved.

8. A deburring tool, with a deburring blade for deburring the edges of holes on workpieces, wherein at least one cutting blade can be held in a tool holder, which can rotate around an axis of rotation in at least one direction of rotation, wherein the cutting blade comprises at least one cutting portion having at least one cutting edge, to which a free surface is associated, which free surface is designed as a cutting part, wherein a control surface is associated with the cutting edge, which control surface is designed as a non-cutting part, wherein the cutting edge transitions into a helically twisted surface, which forms a continuous transition from the cutting part to the non-cutting part, wherein the second cutting edge directly adjoins at an angle the first cutting edge and in that the first cutting edge has an associated free surface, which transitions into the twisted surface which is associated with the second cutting edge.

9. The deburring blade according to claim 1, wherein the cutting edges are straight or arcuate.

10. A deburring tool for deburring the edges of holes on workpieces with a deburring blade according to claim 1.
